(19) United States
(12) Patent Application Publication
(10) Pub. No.: US 2005/0090571 A1
(43) Pub. Date: Apr. 28, 2005

(54) EXPANDED BEAD FOAMS FROM PROPYLENE-DIENE COPOLYMERS AND THEIR USE

(76) Inventors: Aspy Keki Mehta, Humble, TX (US); Pawan Kumar Agarwal, Houston, TX (US)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 10/694,150

(22) Filed: Oct. 27, 2003

(51) Int. Cl. C08J 9/00

(52) U.S. Cl. 521/56

(57) ABSTRACT

Disclosed herein is an expanded olefin resin comprising a copolymer base resin and a blowing agent, wherein the copolymer base resin is comprised of about 90 to 99.999 weight percent of an olefin and about 0.001 to 10 weight percent of an α-ω diene, wherein the copolymer base resin has a weight average molecular weight of about 30,000 to 500,000 Daltons, a crystallization temperature in a range from 115° C. to 135° C., and a melt flow rate in a range from 0.1 dg/min to 100 dg/min as determined using ASTM D-1238 at 230° C. and 2.16 kg load.

### FIELD OF THE INVENTION

The present invention relates to olefinic resin expanded foam beads, particles and the like, and to articles produced therefrom. More particularly, to propylene copolymer resin expanded foam particles formed from the copolymerization of propylene and diene monomers.

### BACKGROUND

Polypropylene is an inexpensive thermoplastic polymer employed in a wide variety of applications. Articles that can be produced with polypropylene include those obtained by molding expanded polypropylene resin beads into an expanded foam.

Articles obtained by foaming and/or expanding expanded polyolefin resin beads in a mold, hereinafter referred to as foamed articles, may demonstrate resistance to chemicals, impact resistance, recovery properties of compression stress, and the like. Accordingly, a foamed article may be employed in packaging, as a shock-absorbing material and/or as a cushioning material such as a core material for an automotive bumper.

Polyolefins and in particular, polypropylene base resins used in expanded beads may be obtained by polymerization using Ziegler-Natta catalyst. Such base resins, however, may not possess properties consistent for use in packaging, shock-absorbing, or other “typical” applications of expanded foams. Polyolefin base resins prepared using metallocene polymerization catalysts, referred to herein as metallocene base resins, may possess at least some of the properties which allow for use of the base resins in expanded foams. For example, the melting point of a metallocene produced polypropylene may be lower than that of a polypropylene resin polymerized using a Ziegler-Natta catalyst.

Accordingly, expanded beads formed from the metallocene-base polypropylene (i.e., propylene polymerized using a metallocene catalyst system) may be molded at a lower temperature and pressures than expanded beads formed from a Ziegler-Natta produced polypropylene. Accordingly, they may produce a more uniform cell diameter of the particles in the final article at lower mold temperatures

U.S. Pat. No. 6,451,419 is directed in part to a shock absorbing material composed of an expansion molded article produced using foamed particles comprising, as a base resin, only a polypropylene homopolymer obtained using a metallocene polymerization catalyst.

U.S. Pat. No. 6,476,089 is directed to expanded polymer beads consisting essentially of a homopolymer or copolymer of propylene with up to 15% by weight of ethylene and/or 1-butene, which may have been blended with up to 50% by weight of a thermoplastic with a glass transition point below 180° C., containing from 1 to 40% of a halogen-free organic blowing agent with a boiling point of from −5 to 150° C., based in each case on the weight of the said propylene homo- or copolymer, wherein the un-foamed beads have a bulk density above 400 g/l and can be foamed to non- crosslinked foamed beads having a bulk density below 200 g/l after storage for one hour at room temperature in free contact with the atmosphere by heating above 100° C.

U.S. Pat. No. 6,313,184 is directed to expanded propylene resin beads, which comprise as a base resin, more than 50% by weight of isotactic random propylene copolymer resin obtained by copolymerizing propylene and at least one comonomer selected from the group consisting of ethylene and alpha-olefins having four or more carbon atoms, in the presence of a metallocene polymerization catalyst, wherein said isotactic random propylene copolymer resin has a melting point in the range of from 141° C. to 160° C. and a melt flow rate of not more than 12 g/10 minutes.

However, articles formed from expanded propylene resin beads comprising homo-polypropylene resin may demonstrate undesirable impact resistance, melt strength, high melt temperatures, and other properties which may be inconsistent with a materials use in a foamed article. As the criteria for expanded propylene resin bead applications and foamed articles formed therefrom continue to evolve, there remains a need to continually modify and improve the physical, mechanical and rheological properties of the polymers contained therein, and in particular those of polypropylene polymer and copolymer base resins, to meet these evolving criteria.

### SUMMARY OF THE INVENTION

Disclosed herein is an expanded olefin resin comprising a copolymer base resin and a blowing agent, wherein the copolymer base resin is comprised of about 90 to 99.999 weight percent of an olefin and about 0.001 to 10 weight percent of an α-ω diene, wherein the copolymer base resin has a weight average molecular weight of about 30,000 to 500,000 Daltons, a crystallization temperature in a range from 115° C. to 135° C., and a melt flow rate in a range from 0.1 dg/min to 100 dg/min as determined using ASTM D-1238 at 230° C. and 2.16 kg load.

Also disclosed is a process to produce the expanded olefin resin, a process of making a foamed article comprising the above disclosed expanded olefin resin, and a foamed article comprising the above disclosed expanded olefin resin.

### DETAILED DESCRIPTION

Ranges are used throughout the description of the invention to further define the invention. Unless otherwise stated, it will be understood that these ranges include the recited end point value(s) as well as those values defined by and/or between the recited end point value(s). Moreover, a range recitation covers all values outside of the recited range, but functionally equivalent to values within the range.

For the purposes of this invention, a catalytically active material may be interchangeably referred to as a catalytic material, or as a catalyst. A catalyst system may comprise a catalyst, an activator, and optionally a support. A reactor is any container(s) in which a chemical reaction occurs. In addition, the numbering scheme for the Periodic Table Groups used herein are as described in CHEMICAL AND ENGINEERING NEWS, 63(5), 27 (1985). Temperatures are listed in degrees Celsius (° C.) unless otherwise noted.

In the description of the copolymer, and particularly when describing the constituents of the copolymer, in some instances, monomer terminology may be used. For example, terms such as “olefin”, “propylene”, “alpha, omega-diene”, “ethylene” and other alpha-olefins can be used. When such monomer terminology is used to describe the copolymer constituents, it is meant to refer to the polymerized units of such monomers present in the copolymer. As used herein, a copolymer may comprise two or more monomers in combination. Accordingly, a copolymer may comprise a plurality of various monomers, homopolymers, and the like.

As used herein, an expanded olefin resin exists in an un-foamed state, and preferably comprises a base resin, more preferably a copolymer base resin or a mixture comprising a copolymer base resin, and an expanding or foaming agent, referred to herein as a blowing agent. The blowing agent may be impregnated, or otherwise disposed within the copolymer base resin of the expanded olefin resin. An expanded olefin resin is capable of being foamed (i.e., expanded) into a foamed article upon the expanded olefin resin being subject to a specific condition or set of conditions such as applying heat and/or reducing the pressure being exerted on the expanded olefin resin. The expanded olefin resin may also include one or more additives that impart various properties to the copolymer base resin, to the expanded olefin resin, to the foamed article, or the like, which are desirable for the intended application and/or use. Accordingly, an expanded olefin bead, form, particle, powder, or the like, refers to discrete portions of an expanded olefin resin, and are collectively referred to herein as expanded olefin resin particles.

Olefins

Preferably, the copolymer base resin comprises a copolymerization reaction product comprising one or more olefin monomers and one or more alpha, omega-diene monomers (α-ω diene). More preferably, the copolymer base resin comprises a metallocene-based copolymerization reaction product comprising one or more olefin monomers and one or more α-ω dienes. Still more preferred are copolymer base resins comprising a metallocene-based copolymerization reaction product comprising propylene (i.e., comprising propylene monomers) and one or more α-ω diene monomers. Preferred copolymer base resins comprise the copolymerization reaction product of two or more olefin monomers and one or more α-ω diene monomers. Preferred olefin monomers include alpha-olefin monomers, particularly propylene and ethylene monomers.

Olefins (polymerizable reactants) suitable for use include ethylene, C₃-C₂₀ alpha-olefins or diolefins (with one of the olefinic functionalities being internal). Examples of alpha-olefins include, for example, propylene, butene-1, pentene-1, hexene-1, heptene-1, 4-methyl-1-pentene, 4-methyl-1-hexene, 5-methyl-1-hexene, 1-octene, 1-decene, 1-undecene, 1-dodecene and the like. In addition, mixtures of these and other alpha-olefins may also be used, such as, for example, propylene and ethylene as well as monomer combinations from which elastomers are formed. Ethylene, propylene, styrene and butene-1 from which crystallizable polyolefins may be formed are particularly desirable.

Preferably, the copolymer base resin comprises a copolymer comprising about 99.95 to about 99.999 wt % alpha-olefins, based on the total weight of the copolymer. Within this range, an alpha-olefin wt % of less than or equal to about 99.9985, can be employed, with less than or equal to about 99.998 preferred, and less than or equal to about 99.997 wt % more preferred. Also preferred within this range is an alpha-olefin wt % of greater than or equal to about 99.955 with greater than or equal to about 99.96 more preferred, and greater than or equal to about 99.97 wt % especially preferred.

In a preferred embodiment, the copolymer comprises about 0.001 to about 0.05 wt % α-ω diene, based on the total weight of the copolymer. Within this range, an α-ω diene wt % of less than or equal to about 0.045 can be employed, with less than or equal to about 0.04 preferred, and less than or equal to about 0.03 wt % more preferred. Also preferred within this range is an α-ω diene wt % of greater than or equal to about 0.0015, with greater than or equal to about 0.002 more preferred, and greater than or equal to about 0.005 wt % especially preferred.

In another embodiment, the copolymer base resin comprises a copolymer comprising propylene and one or more non-propylene olefins. The copolymer preferably comprises about 92 to about 99.95 wt % propylene, based on the total weight of the copolymer. Within this range, a propylene wt % of less than or equal to about 99.9 can be employed, with less than or equal to about 99.5 preferred, and less than or equal to about 99 more preferred. Also preferred within this range is a propylene wt % of greater than or equal to about 94, with greater than or equal to about 96 more preferred, and greater than or equal to about 97 wt % especially preferred.

The non-propylene olefin units, as discussed more fully in detail below, are preferably present in the copolymer at about 0.049 wt % to about 7.95 wt %, based on the total weight of the copolymer. Within this range, a non-propylene olefin wt % of less than or equal to about 5.95 can be employed, with less than or equal to about 3.95 preferred, and less than or equal to about 2.95 more preferred. Also preferred within this range is a non-propylene olefin unit wt % of greater than or equal to about 0.099, with greater than or equal to about 0.499 more preferred, and greater than or equal to about 0.999 wt % especially preferred.

The copolymer preferably has a weight average molecular weight from about 30,000 to 500,000 Daltons, as determined by GPC as discussed more fully herein. Within this range, a weight average molecular weight of less than or equal to 400,000 can be employed, with less than or equal to about 300,000 preferred, and less than or equal to about 200,000 Daltons more preferred. Also preferred within this range is a weight average molecular weight of greater than or equal to about 40,000, with greater than or equal to about 50,000 more preferred, and greater than or equal to about 70,000 Daltons especially preferred.

The copolymer may also have a molecular weight distribution (defined as the ratio of the weight average molecular weight to the number average molecular weight (Mw/Mn) and abbreviated herein as MWD) from about 2 to 20. Within this range, a molecular weight distribution of less than or equal to about 18 can be employed, with less than or equal to about 10 preferred, and less than or equal to about 7 more preferred. Also preferred within this range is a molecular weight distribution of greater than or equal to about 2.1, with greater than or equal to about 2.5 more preferred.

The copolymer preferably has a crystallization temperature (without externally added nucleating agents) greater than or equal to about 115° C. A material having a crystallization temperature of less than or equal to about 130° C. can be employed, with less than or equal to about 125° C. preferred. Also preferred within this range is a material having a crystallization temperature of greater than or equal to about 120° C.

The copolymer preferably has a melt flow rate (MFR) of about 0.1 dg/min to about 100 dg/min, as determined using ASTM D-1238 at 230° C. and 2.16 kg load. Within this range, a melt flow rate of less than or equal to about 50 can be employed, with less than or equal to about 40 preferred, and less than or equal to about 35 dg/min more preferred. Also preferred within this range is a melt flow rate of greater than or equal to about 0.5, with greater than or equal to about 0.7 more preferred, and greater than or equal to about 1 dg/min especially preferred, as determined according to ASTM D-1238, condition L (2.16 kg, 230° C.).

Preferably, the melting point of the copolymer is less than or equal to about 165° C. A melting point of less than or equal to about 160° C. can be employed, with less than or equal to about 155° C. preferred.

Also preferably the hexane extractable level of the copolymer, as measured in accordance with 21 CFR 177.1520(d)(3)(i), may be less than or equal to about 2.0 wt %, based on the total weight of the copolymer. An hexane extractable level of less than or equal to about 1.8 can be employed, with less than or equal to about 1.5 preferred, and less than or equal to about 1 wt % more preferred.

In a preferred embodiment, the copolymer base resin comprises a copolymer comprising a ratio of extensional viscosity at break to linear viscosity of greater than or equal to about 2.5 at strain rates from about 0.1 second⁻¹ to about 1.0 second⁻¹, determined as discussed more fully herein. A ratio of extensional viscosity at break to linear viscosity of greater than or equal to about 3.0 can be employed, with less than or equal to about 3.5 at strain rates from about 0.1 second⁻¹ to about 1.0 second⁻¹ preferred.

As discussed above, the copolymer base resin may also comprise blends of copolymers, including reactor blends with alpha-olefins, particularly homopolymers. For example, a reactor blend with linear polypropylene, more particularly with metallocene catalyzed polypropylene may be used.

Preferably, the copolymer may be described as “branched”. As used herein, the term “branched” refers to inclusion of a α-ω diene unit linkages, between two or more polymer chains formed by the polymerization of one or more alpha-olefins.

Preferably, the branching in the copolymer base resin results in an improved melt strength, as well as other unique physical properties, as compared to non-branched copolymers. The amount of branching may be determined using the weight average branching index g′ of the branched polyolefin, as described for example, in U.S. Pat. No. 6,225,432. The weight average branching index g′ may be defined as g′=[Rg]²_{branched}/[Rg]²ₗᵢₙₑₐᵣ, wherein Rg stands for Radius of Gyration, which can be measured using Multi-Angle Laser Light Scattering. Accordingly, [Rg]_{branched} is the Radius of Gyration for the branched polymer and [Rg]ₗᵢₙₑₐᵣ is the Radius of Gyration of the linear polymer. It follows that the branching index for a linear polymer is 1.0, and for branched polymers the extent of branching is defined relative to the linear polymer. Accordingly, as the value of the branching index g′ decreases, the branching of the copolymer increases.

In the alternative, a branching index may also be defined as g″=[IV]_{branched}/[IV]ₗᵢₙₑₐᵣ, wherein IV is the intrinsic viscosity of the branched and linear polymers, respectively. See B. H. Zimm and W. H. Stockmayer, J. Chem. Phys. 17, 1301 (1949). Preferably, for the polymers disclosed herein, g′ is proportional to g″, more preferably g′ is equal to g″.

Preferably, the weight average branching index g″ is about 0.99 to about 0.6. Within this range, a branching index of less than or equal to about 0.95 can be employed. Also preferred within this range is a branching index of greater than or equal to about 0.65, with greater than or equal to about 0.9 more preferred, and greater than or equal to about 0.93 especially preferred.

Blowing Agents

Blowing agents are volatile expanding agents, which are incorporated or otherwise disposed within the copolymer base resin. Blowing agents are preferably volatile, or can undergo a chemical reaction to become volatile in a temperature range of about negative 200° C. (i.e., −200° C., 73° K.) to about 150° C. (i.e., 423° K.). Preferably, a blowing agent has a boiling point from about −200° C. to about 150° C. Within this range, a boiling point of less than or equal to about 120° C. can be employed, with less than or equal to about 110° C. preferred, and less than or equal to about 100° C. more preferred. Also preferred within this range is a boiling point of greater than or equal to about −195° C., with greater than or equal to about −170° C. more preferred, and greater than or equal to about −80° C. especially preferred.

The concentration of the blowing agent added and/or impregnated within the copolymer base resin to form the expanded polyolefin resin may vary, depending on the blowing agent or agents used, the bulk densities of copolymer base resin of interest, and the conditions under which the expanded polyolefin resin is to be foamed. Preferably, the concentration of the blowing agent in the expanded polyolefin resin is about 0.01 wt %, to about 40 wt %, based on the total weight of the copolymer base resin.

According to the present invention, the blowing agent may include an aliphatic hydrocarbon such as butane, pentane, hexane and/or heptane. A halogenated hydrocarbon such as trichlorofluoromethane, dichlorodifluoromethane, tetrachloroethane, dichlorotetrafluoroethane, methylene chloride and/or ethyl chloride may also be used alone or in combination with one or more of the above blowing agents. The blowing agent may also comprise water, either alone or in combination with an organic or inorganic blowing agent. The blowing agent may also comprise an organic gaseous material such as methane, ethane, ethylene, propylene, ethyn, propyne, and/or the like. In a preferred embodiment, the blowing agent comprises nitrogen, oxygen, air, helium, argon, and/or carbon dioxide.

The blowing agent may also comprise components capable of undergoing a chemical reaction to produce a volatile material. For example, the blowing agent may comprise an organic acid, an inorganic acid, and/or a salt of a carbonic acid, which combines to produce CO₂. In a preferred embodiment, the organic acid comprises citric acid, or a salt thereof, and the salt of carbonic acid comprises sodium carbonate, sodium bicarbonate, ammonium carbonate, ammonium bicarbonate, potassium carbonate, potassium bicarbonate, or a combination comprising at least one of the foregoing.

Additives and Modifiers

Suitable additives include those employed with olefinic polymers, copolymers and blends. Examples include one or more of the following: heat stabilizers, antioxidants, neutralizers, slip agents, antiblock agents, pigments, antifogging agents, antistatic agents, clarifiers, nucleating agents, ultraviolet absorbers or light stabilizers, fillers, hydrocarbon resins, rosins or rosin esters, waxes, additional plasticizers, hydrogenated hydrocarbon resins, and other plasticizers may be used as modifiers either alone, or in combination with other additives. Effective levels of additives may depend on the details of the copolymer base resin, the fabrication mode, the end application, and the like. Suitable level of additives, when present, are typically less than or equal to about 50 wt %, based on the total weight of the copolymer base resin.

It is within the scope of the present invention to blend additives, other resins and elastomers with the polypropylene resin polymerized in the presence of the metallocene compound as the catalyst. As such, more than one additive may be added, for example, an antioxidant, an ultraviolet light absorber, an antistatic agent, a flame-retardant, a metal inactivating agent, a pigment, a dye and a nucleating agent, can be added according to the necessity. The preferred amount of additives, which depends on the properties required, is about 20 parts by weight or less, preferably 5 parts by weight or less, based on 100 parts by weight of the copolymer base resin of the present invention.

The copolymer base resin may also comprise a variety of resins polymerized in the presence of a Ziegler-Natta catalyst, such as a polypropylene resin, high density polyethylene, linear low-density polyethylene, super-low-density polyethylene; polymers produced by the high pressure method such as a low-density polyethylene, polyolefin resins such as ethylene-vinyl acetate copolymer, ethylene-acrylate copolymer, ethylene-acrylic acid copolymer, ethylene-methacrylic acid copolymer, and ethylene-carbon monoxide copolymer; and a variety of thermoplastic resins including amorphous polystyrene resin, crystalline polystyrene resin, vinyl chloride resin, polyamide resin, polyacetal resin, polycarbonate resin, and the like. When present, the amount of the resin to be blended is preferably about 100 parts by weight or less, more preferably about 50 parts by weight or less, still more preferably about 10 part by weight, per 100 parts by weight of the total copolymer base resin.

The copolymer base resin may also comprise elastomers. Preferred elastomers include solid rubbers such as ethylene-propylene rubber, ethylene-1-butene rubber, propylene-1-butene rubber, styrene-butadiene rubber, and/or hydrogenated products thereof. The copolymer base resin may also include elastomers such as polystyrene elastomers, for example styrene-butadiene block copolymeric elastomer can be used. Preferable elastomers also include elastomeric olefin polymers such as ethylene-propylene rubber, ethylene-butene-1 rubber, and propylene-butene-1 rubber, preferably those having a Mooney viscosity of 1 to 100 determined by a method of ASTM D 1646 with the L-rotor at 100° C.

Accordingly, the copolymer may be blended with other polymers, particularly with other polyolefins, both in-reactor as well as externally. Specific examples of preferred materials include, but are not limited to, ethylene-propylene rubber, ethylene-propylene diene rubber, and ethylene plastomers such as those resins commercially available under the trade name EXACT (ExxonMobil Chemical Company) AFFINITY and, ENGAGE (Dow Chemical Company). Reactor blends with ethylene and/or propylene-based plastomers or elastomers are also within the scope of the invention.

Other copolymers, terpolymers, and the like, which may be used in combination with the polypropylene—α-ω diene copolymer include those comprising ethylene and butene in the form of random copolymers and impact copolymers. Random copolymers preferably comprise up to about 6% (by weight) of ethylene or other comonomers inserted at random within the backbone chain of the polymer thereby reducing the crystallinity and the melting point by introducing irregularities into the chain. Random copolymers may be used to improve optical clarity, to lower melting point, or when a lower modulus is desirable. See for example U.S. Pat. No. 6,583,227.

Impact copolymers, also known as heterophasic copolymers, preferably comprise up to about 40 wt % ethylene-propylene rubber (EPR), intimately dispersed within the matrix, usually a homopolymer. An EPR comprising about 50 wt % ethylene, translates into about 8% to about 20% ethylene level on the total material, depending on the rubber amount incorporated. As implied in the name, impact copolymers preferably improve impact strength of the article, especially at low temperatures. See Polypropylene Handbook, Edward P. Moore, ed., page 5, Hanser Publishers, 1996.

Examples of impact copolymers suitable for use herein include those described in U.S. Pat. No. 5,258,464; U.S. Pat. No. 5,362,782, a nucleating agent is added to propylene impact copolymers having a numerical ratio of the intrinsic viscosity of the copolymer rubber phase (second component) to the intrinsic viscosity of the homopolymer phase (first component) which is near unity, and an ethylene content of the copolymer phase in the range of 38% to 60% by weight. These propylene impact copolymers are described as producing articles having good clarity as well as impact strength and resistance to stress whitening. The nucleating agents increase stiffness and impact strength; U.S. Pat. No. 5,250,631 directed to a propylene impact copolymer having a homopolypropylene first component and an ethylene/butene/propylene terpolymer second component to obtain high impact strength coupled with resistance to stress whitening; U.S. Pat. No. 5,948,839, directed to an impact copolymer containing a first component and 25 to 45 weight percent ethylene/propylene second component having from 55 to 65 weight percent ethylene, to produce a composition having a melt flow of from 7 to 60 dg/min; and U.S. Pat. No. 5,990,242, directed to using an ethylene/butene (or higher alpha-olefin) copolymer second component, rather than a propylene copolymer, prepared using a hafnocene type metallocene. See also U.S. Pat. Nos. 6,492,266, 6,492,473, 6,492,465, 6,472,474, 6,399,707, 6,384,142, 6,342,566, 6,288,171, 6,268,438, 6,225,412, 6,111,039, 6,087,459, 5,747,592, 5,225,483, 5,066,723, 5,011,891, and 4,843,129, all of which are fully incorporated by reference herein.

Dienes

Examples of suitable α-ω dienes include α-ω dienes that contain at least 7 carbon atoms and have up to about 30 carbon atoms, more suitably are α-ω dienes that contain from 8 to 12 carbon atoms. Representative examples of such α-ω dienes include 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, and the like. Of these, 1,7-octadiene, and 1,9-decadiene are more desirable; particularly desirable is 1,9-decadiene. The diene content can be estimated, for example, by measuring absorbance at 722 cm⁻¹ using infrared spectroscopy. Branched, substituted α-ω dienes, for example 2-methyl-1,9-decadiene, 2-methyl-1,7-octadiene, 3,4-dimethyl-1,6-heptadiene, 4-ethyl-1,7-octadiene, or 3-ethyl-4-methyl-5-propyl-1,10-undecadiene are also envisioned.

While α-ω dienes are preferred, other dienes can also be employed to make polymers of this invention. The other dienes preferably result in cross linking of the copolymer base resin. Such other dienes preferably include cyclic dienes, such as vinylnorbomene, or aromatic types, such as divinyl benzene.

Catalyst Composition

Catalyst preferred for use herein include metallocene type catalysts. As used herein “metallocene” and “metallocene component” refer generally to compounds represented by the formula CpₘMRₙX_{q} wherein Cp is a cyclopentadienyl ring which may be substituted, or derivative thereof which may be substituted, M is a Group 4, 5, or 6 transition metal, for example titanium, zirconium, hafnium, vanadium, niobium, tantalum, chromium, molybdenum and tungsten, R is a hydrocarbyl group or hydrocarboxy group having from one to 20 carbon atoms, X is a halogen, and m=1-3, n=0-3, q=0-3, and the sum of m+n+q is equal to the oxidation state of the transition metal.

Methods for making and using metallocenes include those detailed in U.S. Pat. Nos. 4,530,914; 4,542,199; 4,769,910; 4,808,561; 4,871,705; 4,933,403; 4,937,299; 5,017,714; 5,026,798; 5,057,475; 5,120,867; 5,278,119; 5,304,614; 5,324,800; 5,350,723; and 5,391,790 each fully incorporated herein by reference.

Methods for preparing metallocenes are fully described in the Journal of Organometallic Chem., volume 288, (1985), pages 63-67, and in EP-A-320762, both of which are herein fully incorporated by reference.

Metallocene catalyst components are described in detail in U.S. Pat. Nos. 5,145,819; 5,243,001; 5,239,022; 5,329,033; 5,296,434; 5,276,208; 5,672,668; 5,304,614; 5,374,752; 5,240,217; 5,510,502 and 5,643,847; and EP 549 900 and 576 970 all of which are herein fully incorporated by reference.

Illustrative but non-limiting examples of desirable metallocenes include:
Dimethylsilanylbis (2-methyl-4-phenyl-1-indenyl)ZrCl₂;
Dimethylsilanylbis(2-methyl-4,6-diisopropylindenyl)ZrCl₂;
Dimethylsilanylbis(2-ethyl-4-phenyl-1-indenyl)ZrCl₂;
Dimethylsilanylbis (2-ethyl-4-naphthyl-1-indenyl)ZrCl₂,
Phenyl(Methyl)silanyl bis(2-methyl-4-phenyl 1-1-indenyl)ZrCl₂,
Dimethylsilanyl bis(2-methyl-4-(1-naphthyl)-1-indenyl)ZrCl₂,
Dimethylsilanylbis(2-methyl-4-(2-naphthyl)-1-indenyl)ZrCl₂,
Dimethylsilanylbis(2-methyl-indenyl)ZrCl₂,
Dimethylsilanylbis(2-methyl-4,5-diisopropyl-1-indenyl)ZrCl₂,
Dimethylsilanylbis(2,4,6-trimethyl-1-indenyl)ZrCl₂,
Phenyl(Methyl)silanylbis(2-methyl-4,6-diisopropyl-1-indenyl)ZrCl₂,
1,2-Ethandiylbis(2-methyl-4,6-diisopropyl-1-indenyl)ZrCl₂,
1,2-Butandiylbis(2-methyl-4,6-diisopropyl-1-indenyl)ZrCl₂,
Dimethylsilanylbis(2-methyl-4-ethyl-1-indenyl)ZrCl₂,
Dimethylsilanylbis(2-methyl-4-isopropyl-1-indenyl)ZrCl₂,
Dimethylsilanylbis(2-methyl-4-t-butyl-1-indenyl)ZrCl₂,
Phenyl(Methyl)silanylbis(2-methyl-4-isopropyl-1-indenyl)ZrCl₂,
Dimethylsilanylbis(2-ethyl-4-methyl-1-indenyl)ZrCl₂,
Dimethylsilanylbis(2,4-dimethyl-1-indenyl)ZrCl₂,
Dimethylsilanylbis(2-methyl-4-ethyl-1-indenyl)ZrCl₂,
Dimethylsilanylbis(2-methyl-1-indenyl )ZrCl₂,
   Activators:

Metallocenes are generally used in combination with some form of activator. Alkylalumoxanes may be used as activators, most desirably methylalumoxane (MAO). There are a variety of methods for preparing alumoxane non-limiting examples of which are described in U.S. Pat. Nos. 4,665,208, 4,952,540, 5,091,352, 5,206,199, 5,204,419, 4,874,734, 4,924,018, 4,908,463, 4,968,827, 5,308,815, 5,329,032, 5,248,801, 5,235,081, 5,103,031 and EP-A-0 561 476, EP-B1-0 279 586, EP-A-0 594-218 and WO94/10180, each fully incorporated herein by reference. Activators may also include those comprising or capable of forming non-coordinating anions along with catalytically active metallocene cations. Compounds or complexes of fluoro aryl-substituted boron and aluminum are particularly suitable; see, e.g., U.S. Pat. Nos. 5,198,401; 5,278,119; and 5,643,847.

Support Materials:

The catalyst compositions used in the process of this invention may optionally be supported using a porous particulate material, such as for example, clay, talc, inorganic oxides, inorganic chlorides and resinous materials such as polyolefin or polymeric compounds.

Preferably, the support materials are porous inorganic oxide materials, which include those from the Periodic Table of Elements of Groups 2, 3, 4, 5, 13 or 14 metal oxides. Silica, alumina, silica-alumina, and mixtures thereof are particularly desirable. Other inorganic oxides that may be employed either alone or in combination with the silica, alumina or silica-alumina are magnesia, titania, zirconia, and the like.

A particularly preferred support material is particulate silicon dioxide. Particulate silicon dioxide materials are well known and are commercially available from a number of commercial suppliers. Desirably the silicon dioxide used herein is porous and has a surface area in the range of from about 10 to about 700 m²/g, a total pore volume in the range of from about 0.1 to about 4.0 cc/g and an average particle diameter in the range of from about 10 to about 500 micrometers. More desirably, the surface area is in the range of from about 50 to about 500 m²/g, the pore volume is in the range of from about 0.5 to about 3.5 cc/g and the average particle diameter is in the range of from about 15 to about 150 micrometers. Most desirably the surface area is in the range of from about 100 to about 400 m^{2/}g, the pore volume is in the range of from about 0.8 to about 3.0 cc/g and the average particle diameter is in the range of from about 20 to about 100 micrometers. The average pore diameter of typical porous silicon dioxide support materials is in the range of from about 10 to about 1000 Å. Desirably, the support material has an average pore diameter of from about 50 to about 500 Å, and most desirably from about 75 to about 350 Å. Desirably, supports suitable for use in this invention include talc, clay, silica, alumina, magnesia, zirconia, iron oxides, boria, calcium oxide, zinc oxide, barium oxide, thoria, aluminum phosphate gel, polyvinylchloride and substituted polystyrene and mixtures thereof.

The supported catalyst composition may be used directly in polymerization or the catalyst composition may be prepolymerized using methods well known in the art. For details regarding prepolymerization, see U.S. Pat. Nos. 4,923,833; 4,921,825; and 5,643,847; and EP 279 863 and EP 354 893 (each fully incorporated herein by reference).

Polymerization

The copolymer, which is the copolymerization reaction product of α-ω diene(s) and olefin(s), may be prepared by slurry polymerization of the olefins and diene under conditions in which the catalyst site remains relatively insoluble and/or immobile so that the polymer chains are rapidly immobilized following their formation. Such immobilization is affected, for example, by (1) using a solid, insoluble catalyst, (2) conducting the copolymerization in a medium in which the resulting copolymer is generally insoluble, and (3) maintaining the polymerization reactants and products below the crystalline melting point of the copolymer.

The metallocene supported catalyst compositions described above, are desirable for copolymerizing α-ω dienes and olefins. The polymerization processes suitable for copolymerizing α-ω dienes and olefins, and particularly alpha-olefins, are well known by those skilled in the art and include solution polymerization, slurry polymerization, and low pressure gas phase polymerization. Metallocene supported catalysts compositions are particularly usefuil in the known operating modes employing fixed-bed, moving-bed, fluid-bed, or slurry processes conducted in single, series or parallel reactors.

Any of the above polymerization process may be used. When propylene is the selected olefin, a common propylene polymerization process is one that is conducted using a slurry process in which the polymerization medium can be either a liquid monomer, like propylene, or a hydrocarbon solvent or diluent, advantageously aliphatic paraffin such as propane, isobutane, hexane, heptane, cyclohexane, etc. or an aromatic diluent such as toluene. In this instance, the polymerization temperatures may be those considered low, e.g., less than 50° C., desirably 0°C.-30° C., or may be in a higher range, such as up to about 150° C., desirably from 50° C. up to about 80° C., or at any ranges between the end points indicated. Pressures can vary from about 100 to about 700 psia (0.69-4.8 MPa). Additional description is given in U.S. Pat. Nos. 5,274,056 and 4,182,810 and WO 94/21962 which are each fully incorporated by reference.

More particularly, the polymerization method of forming a propylene/α-ω diene copolymer includes contacting a catalyst, and desirably a metallocene catalyst, under suitable polymerization conditions with polymerizable reactants, such as propylene monomers, and α-ω diene monomers and recovering the propylene/α-ω diene copolymer. Desirably the metallocene catalyst may be a zirconium metallocene catalyst. Additionally, the contacting step may include hydrogen and ethylene monomers. The hydrogen, in ppm, may be present in the range of 100 to 50,000 and desirably from 500 to 20,000 and most desirably from 1,000 to 10,000 measured as gas phase concentration in equilibrium with liquid propylene at polymerization temperatures.

Pre-polymerization may also be used for further control of polymer particle morphology in slurry or gas phase reaction processes. For example, this can be accomplished by pre-polymerizing a C₂-C₆ alpha-olefin for a limited time. For example, ethylene may be contacted with the supported metallocene catalyst composition at a temperature of −15 to 30° C. and ethylene pressure of up to about 250 psig (1724 kPa) for 75 min. to obtain a polyethylene coating on the support. The pre-polymerized catalyst is then available for use in the polymerization processes referred to above. In a similar manner, the activated catalyst on a support coated with a previously polymerized polymer can be utilized in these polymerization processes.

Additionally, it is desirable to reduce or eliminate polymerization poisons that may be introduced via feed streams, solvents or diluents, by removing or neutralizing the poisons. For example, monomer feed streams or the reaction diluent may be pre-treated, or treated in situ during the polymerization reaction, with a suitable scavenging agent. Typically such will be an organometallic compound employed in processes such as those using the Group-13 organometallic compounds of U.S. Pat. No. 5,153,157 and WO-A-91/09882 and WO-A-94/03506, noted above, and that of WO-A-93/14132.

Copolymer Base Resin

To produce the copolymer base resin, the aforementioned and the other components may be blended, added to, or otherwise incorporated with or into the copolymer base resin, preferably the polypropylene copolymer base resin. In a preferred embodiment, the various components are incorporated into the polypropylene copolymer base resin in a fluid state and/or solid state. Accordingly, melt kneading and the like is preferred. Kneading may be conducted at a desired temperature with a variety of kneaders such as a roll, an extruder, a Banbury mixer, a kneader, a blender or a mill. After kneading, the product may be granulated into appropriate sized particles, beads, or other forms suitable for forming foamed articles. Granulation may include grinding, chopping, the strand cut method, the underwater cut method, the hot cut method, the mist cut method, the sheet cut method, the freeze grinding method, and/or the melt spray method.

The expanded particles (i.e., the copolymer base resin impregnated with blowing agent) may be prepared by various methods. The process to produce the expanded olefin resin, comprises contacting a copolymer base resin with a blowing agent, preferably under a pressure greater than or equal to atmospheric pressure, also preferably while heating the copolymer base resin and the blowing agent to a temperature greater than or equal to the softening point of the olefin copolymer base resin.

Examples include an embodiment wherein the copolymer base resin particles are impregnated with the blowing agent to produce discrete expanded particles comprising the blowing agent. In another embodiment, the impregnating of the copolymer base resin is an intermediate step in forming the foamed article. In this embodiment, particles of the base copolymer are impregnated in the mold, or in a chamber or other piece of equipment prior to being placed in the mold within which the foamed article is to be produced. In still another embodiment, the blowing agent is incorporated into the copolymer during an extrusion or other mixing process, wherein the foamed article is produced upon exiting the extruder.

To produce discrete expanded particles (i.e., the copolymer base resin impregnated with the blowing agent), the process comprises dispersing the copolymer base resin particles in a liquid, preferably an aqueous liquid comprising a dispersant, in a closed container. Examples of the dispersant which may preferably be used for dispersing the resin particles in water are inorganic suspending agents such as aluminum oxide, titanium oxide, calcium carbonate, magnesium carbonate (basic), calcium tertiary phosphate and magnesium pyrophosphate; water-soluble polymeric protective colloids such as polyvinyl alcohol, methylcarboxycellulose and N-polyvinylpyrrolidone; and anionic surface active agents such as sodium dodecylbenzenesulfonate, a sodium alkanesulfonate, a sodium alkylsulfate, a sodium olefinsulfate, an acylmethyltaurine and a sodium dialkylsulfosuccinate.

Among these, it is preferable to use a combination of calcium tertiary phosphate having a particle diameter of 0.01 to 0.8 micrometers and sodium dodecylbenzenesulfonate as a suspending aid. The fine tertiary calcium phosphate is obtained by reacting 0.60 to 0.67 mole of phosphoric acid with 1 mole of calcium hydroxide in water.

The amount of water as the dispersing medium is in a proportion of 150 to 1,000 parts by weight, preferably 200 to 500 parts by weight to 100 parts by weight of the resin particles. If it is less than 150 parts by weight, the resin particles tend to cause blocking during pressurization. If it exceeds 1,000 parts by weight, the productivity of the expanded particles is uneconomically decreased.

Preferably, the blowing agent is then supplied to the closed container, followed by heating the dispersion to a temperature of at least the softening point of the copolymer base resin particles. However, the blowing agent may be added prior to, during, or after the heating of the reactor contents. The blowing agent may also be introduced all at once, or in portions.

After heating at a suitable temperature for a suitable amount of time, an outlet provided below the surface of the dispersion in the closed container is then opened, thus discharging the aqueous dispersion containing the resin particles having the blowing agent impregnated therein into an atmosphere having a pressure lower than that in the closed container (e.g., into the atmospheric air). An inorganic gas such as nitrogen, helium, argon, carbon dioxide gas or air is preferably supplied to the closed container to provide pressure before or after the addition of the blowing agent to the closed container in the preparation of the expanded particles. Accordingly, the inorganic gas may be supplied either before or after the heating of the dispersion. The supply of the inorganic gas such as air, nitrogen gas, helium, argon or carbon dioxide gas facilitates the impregnation of the blowing agent into the resin particles.

In a preferred embodiment, polypropylene/α-ω diene copolymer base resin particles as described above, are dispersed in water with the dispersant, and carbon dioxide is supplied as a gaseous expanding blowing agent to a closed container. Next, the dispersion is heated to a temperature of at least the softening point of the copolymer base resin particles, so that the pressure within the container is increased with the heating, and the expanding agent is impregnated into the resin particles. The resin particles are then discharged together with the water and dispersant from an outlet, for example, a slit or a nozzle, provided at the lower part of the closed container into a lower pressure region (e.g., into atmospheric air) thus to produce polypropylene/α-ω diene copolymer base resin expanded particles.

In one embodiment, the expanded particles may be discharged and dried/aged at about 30° C. to 65° C. to remove water adhering to the surface and are used for foaming, preferably in a mold to produce, for example, bumper core materials, packaging containers, and the like.

The polypropylene resin expanded particles according to the present invention can be in any particle size, but preferably have a particle size such that the particles passes through a sieve having 2.5 mesh (Tyler series) but which are retained on a sieve having 30 mesh Tyler series. The particles may be of various shapes from true spherical to cylindrical.

A preferred process to produce a foamed article comprising a foamed expanded olefin resin comprises heating the expanded olefin resin, reducing the pressure being applied to the expanded olefin resin, or both, to produce an expanded foamed article. This process is preferably carried out in a mold which approximates the final shape of the article. However, the formed article, once formed may require additional processing before becoming a final product.

A variety of methods for foaming and/or molding the expanded particles or beads of the present invention into shaped foamed articles may be used. For example, the compression molding method in which, after the expanded polyolefin particles have been placed in a mold, the particles are compressed so as to reduce the volume by 15 to 50% and are fused together, preferably by introducing steam at 1 to 5 kg/cm³ g. The mold is then cooled to obtain a molded product. In another embodiment, the expanded particles are partially expanded either within a mold or otherwise, and then again impregnated with a blowing agent as described above.

Next, the twice-impregnated particles are placed in a mold, heated, preferably with steam to cause secondary expansion as well as to fuse the particles together. In another embodiment, the expanded particles are introduced into a closed chamber, into which an inorganic gas such as air or nitrogen gas is introduced under pressure, whereby the pressure within the cells of the expanded particles is increased to impart the secondary expanding capability, and the resulting particles with the secondary expanding capability are placed in a mold, heated, preferably with steam to carry out secondary expansion as well as to fuse the particles together (See for example the so-called “pressurized aging” method as disclosed in U.S. Pat. No. 4,379,859; and EP-53333-A).

In still another embodiment, the expanded particles may be sequentially introduced portionwise under compression with a pressurizing gas at a pressure higher than the pressure within the mold by 0.5 kg/cm² or more, the pressure within the mold preferably being about 1.0 to 6.0 kg/cm² and maintained with a pressurized gas. Accordingly, the pressure within the mold is maintained during filling and reduced again to atmospheric pressure after the filling. The expanded particles are then heated, preferably with steam, and fused together to control the compression ratio of the expanded particles represented by the equation:
Compression ratio (%)=[(W/ρ)−V)/[W/ρ]*100
wherein W, V and ρ, respectively, are defined as follows:
W: weight (g) of the molded product,
V: volume (liter) of the molded product,
ρ: bulk density (g/liter) of the expanded particle in air.
   The compression ratio is preferably in the range of about 40 to 70%.

The expanded particles or beads of the present invention may also be shaped into articles using a method in which, into a mold of a pressure raised to 0.5 to 5.0 kg/cm² with a pressurized gas, expanded particles are sequentially filled portionwise the expanded particles having a gas internal pressure obtained by a preliminary pressurizing treatment with a pressurized gas having a pressure higher than that in the mold by 0.5 kg/cm² or more for 1 hour or more, the pressure within the mold being maintained at the above stated pressure within the mold during the filling and reduced again to atmospheric pressure after the filling, and the expanded particles are heated, preferably with steam, and fused together to control the compression ratio of the expanded particles represented by the equation set forth above to less than 40% (exclusive of 0%). In still another method, expanded particles having secondary expanding capability are introduced into a mold cavity or into a mold to fill the same under pressure and heated, preferably with steam, to conduct secondary expansion as well as to fuse the particles together (See for example, U.S. Pat. Nos. 4,777,000 and 4,720,509).

Preferably, the copolymer particles may be directly impregnated with the blowing agent while in a mold designed to produce an intended article, or within a chamber or reactor prior to, but in fluid communication with, the mold. In this embodiment, the particles are charged to the mold, wherein the blowing agent is impregnated into the copolymer particles, preferably under pressure while being heated to about the softening point of the copolymer. Once the blowing agent is impregnated within the copolymer, the pressure is preferably released, and/or more heat is applied causing the impregnated copolymer particles to expand and fuse, thus forming the intended foamed article.

Any of the above described methods may be used and is selected in consideration of the nature of the expanded particles or the shape or density of the molded product. The methods may be found, for example, in the Encyclopedia of Chemical Technology, by Kirk-Othmer, Fourth Edition, vol. 11, at pages 730-783, which are incorporated by reference herein.

In a preferred embodiment, the blowing agent may be incorporated directly into the copolymer during a blending, extrusion, and/or during a kneading process. Preferably, the blowing agent is incorporated into the copolymer under pressure while applying heat during an extrusion process. The extrudate may then be exposed to atmospheric or reduced pressure (relative to the pressure being applied to the copolymer), preferably while heating through a die or other orifice, causing the impregnated copolymer to expand as the blowing agent is released, thereby producing a foamed article such as a sheet, bar or the like. In this embodiment, the blowing agent may be incorporated into the copolymer as a solid, liquid, and/or directly incorporated (impregnated) into the copolymer as a gas during this procedure. The optimum pressures, temperatures and concentrations of blowing agent required during processing are related to the blowing agent used, and the desired density of the extruded foam article produced.

A preferred concentration of blowing agent is about 0.01 wt % to about 40 wt %, based on the total weight of the blowing agent to the total weight of the copolymer base resin. Within this range, a blowing agent concentration of less than or equal to about 20% can be employed, with less than or equal to about 10% preferred, and less than or equal to about 5% more preferred, based on the total amount of copolymer base resin present. Also preferred within this range is a blowing agent concentration of greater than or equal to about 0.1%, with greater than or equal to about 0.5% more preferred, and greater than or equal to about 1% especially preferred, based on the total amount of copolymer base resin present.

The foamed article produced herein preferably has a bulk density of about 0.001 g/ml to about 0.8 g/ml. Within this range, a foam bulk density of less than or equal to about 0.6 g/ml can be employed, with less than or equal to about 0.5 g/ml preferred, and less than or equal to about 0.4 g/ml more preferred. Also preferred within this range is a foam bulk density of greater than or equal to about 0.01 g/ml, with greater than or equal to about 0.05 g/ml more preferred, and greater than or equal to about 0.1 g/ml especially preferred.

Foamed articles are particularly useful for construction and automotive applications. Examples of construction applications include heat and sound insulation, industrial and home appliances, and packaging. Examples of automotive applications include interior and exterior automotive parts, such as bumper guards, dashboards and interior liners.

### EXAMPLES

A diene polypropylene copolymer according to the present invention was expanded into a foamed article to produce an Example, for direct comparison with a Comparative Example produced from a commercially available material, Montell PF-814. The diene propylene resin was produced as described above. The Example and the Comparative Example were both foamed via extrusion using CO₂ as the injection-blowing agent.

Experiments were conducted on a 2.5 inch diameter disk having a depth of 0.8 inches. Consolidation (i.e., foaming) of the polymers was conducted in a one step process. The resultant foamed disks produced were tested according to standard procedures know to those of skill in the art. In particular, the melt flow rate was determined on the copolymer prior to foaming, according to ASTM D-1238 at 230° C. and 2.16 kg load. Foam density was determined by measuring the physical dimensions of the foamed disk and calculating the ratio of the disk mass to the volume. Hardness (Shore A scale) was measured according to ASTM-D2240-86. Cell size was determined by observing a cross section of the disk, and measuring the cell size utilizing a graduated optical microscope. Compression Set (Recovery) was determined according to ISO 1856. Compression Modulus was measured according to ISO 844. Compressive Stress at 10% strain was measured according to ASTM B1621. The data for the Example and the Comparative Example are listed in the Table below:

| | Example | | Comparative Example | |
|---|---|---|---|---|
| | | Std. | | Std. |
| Property Measured | Mean | Deviation | Mean | Deviation |
| Melt Flow Rate | 5.6 | | 3.0 | |
| Foam Density | 0.12 | Not | 0.12 | Not |
| (g/cc) | | determined | | determined |
| Shore A Hardness | 60.2 | 7.4 | 63.5 | 2.1 |
| Cell Size | 0.074 | 0.008 | 0.074 | 0.006 |
| Center | | | | |
| (mm) | | | | |
| Cell Size | 0.073 | 0.009 | 0.071 | 0.005 |
| Edge | | | | |
| (mm) | | | | |
| Compression Set | | | | |
| % Recovery after | 66.4 | 3.2 | 59.9 | 3.2 |
| 30 min | | | | |
| % Recovery after | 69.9 | 3.0 | 64.3 | 3.3 |
| 24 hours | | | | |
| Compression | 1763 | 84 | 1958 | 69 |
| Modulus (psi) | | | | |
| Max force at 10% | 17.6 | 2.5 | 20.2 | 0.4 |
| compression | | | | |
| (lbs) | | | | |
| Max force at 50% | 204 | 14 | 244 | 7 |
| compression | | | | |
| (lbs) | | | | |

The similar densities and cell sizes of the Example and the Comparative Example indicate a head to head comparison between the two samples. Comparing the hardness of the Example to the Comparative Example, using the SHORE-A scale, the two exhibit essentially the same response. Comparing the data for compression set, it has been unexpectedly discovered that real differences in the two material's properties may exist. In this respect, the Example is superior to the standard in the art as elasticity, even in rigid foams, may be desired.

The compression modulus values again may be used to distinguish the two samples. The lower modulus of the Example with respect to the Comparative Example demonstrates a lower compression set value. Since the modulus of the Example is lower, a lower compression set value may be expected. Clearly, lower set values are desired as they may indicate shape retention characteristic of a typical foamed article. Accordingly, the Example may achieve an improvement of shape retention over the prior art.

While the present invention has been described and illustrated by reference to particular embodiments, it will be appreciated by those of ordinary skill in the art that the invention lends itself to many different variations not illustrated herein. For these reasons, then, reference should be made solely to the appended claims for purposes of determining the true scope of the present invention.

Although the appendant claims have single appendencies in accordance with U.S. patent practice, each of the features in any of the appendant claims can be combined with each of the features of other appendant claims or the main claim.

1. An expanded olefin resin comprising:
a copolymer base resin and a blowing agent,
the copolymer base resin comprising about 99.95 to 99.999 weight percent of an olefin and about 0.001 to 0.05 weight percent of an α-ω diene, wherein the copolymer base resin has a weight average molecular weight of about 30,000 to 500,000 Daltons, a crystallization temperature of about 115° C. to 135° C., and a melt flow rate of about 0.1 dg/min to 100 dg/min as determined using ASTM D-1238 at 230° C. and 2.16 kg load.

2. The expanded olefin resin of claim 1, wherein the α-ω diene includes 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, 2-methyl-1,9-decadiene, 2-methyl-1,7-octadiene, 3,4-dimethyl-1,6-heptadiene, 4-ethyl-1,7-octadiene, 3-ethyl-4-methyl-5-propyl-1,10-undecadiene, or a combination comprising at least one of the foregoing dienes.

3. The expanded olefin resin of claim 1, wherein the copolymer base resin comprises ethylene, propylene, butene-1, pentene-1, hexene-1, heptene-1, 4-methyl-1-pentene, 3-methyl-1-pentene, 4-methyl-1-hexene, 5-methyl-1-hexene, 1-octene, 1-decene, 1-undecene, 1-dodecene, or a combination comprising at least one of the foregoing.

4. The expanded olefin resin of claim 1, wherein the copolymer base resin comprises a metallocene-based copolymerization reaction product comprising propylene and one or more α-ω diene monomers.

5. The expanded olefin resin of claim 1, wherein a ratio of the weight average molecular weight to the number average molecular weight of the copolymer base resin is about 2 to about 20.

6. The expanded olefin resin of claim 1, wherein a ratio of the weight average molecular weight to the number average molecular weight of the copolymer base resin is about 2.5 to about 7.

7. The expanded olefin resin of claim 1, wherein the copolymer base resin has a melting point of less than or equal to about 165° C.

8. The expanded olefin resin of claim 1, wherein the copolymer base resin has a ratio of extensional viscosity at break to linear viscosity of greater than or equal to about 2.5 at a strain rate from about 0.1 second⁻¹ to about 1.0 second⁻¹.

9. The expanded olefin resin of claim 1, which is capable of being foamed into an article to produce a foamed resin article having a bulk density of about 0.001 g/ml to about 0.8 g/ml.

10. The expanded olefin resin of claim 1, wherein the copolymer base resin has a branching index g″ of about 0.99 to about 0.6, as determined from the equation:
g″=[IV]_{branched}/[IV]ₗᵢₙₑₐᵣ
wherein IV is the intrinsic viscosity of the branched and linear polymers, respectively.

11. The expanded olefin resin of claim 10, wherein the branching index g″ is about 0.99 to about 0.93.

12. The expanded olefin resin of claim 1, wherein the blowing agent comprises an organic acid, an inorganic acid, a salt of a carbonic acid, or a combination comprising at least one of the foregoing.

13. The expanded olefin resin of claim 12, wherein the organic acid comprises citric acid, and wherein the salt of carbonic acid comprises sodium carbonate, sodium bicarbonate, ammonium carbonate, ammonium bicarbonate, potassium carbonate, potassium bicarbonate, or a combination comprising at least one of the foregoing.

14. The expanded olefin resin of claim 1, wherein the blowing agent comprises methane, ethane, ethylene, propylene, ethyn, propyne, butane, pentane, hexane, heptane, trichlorofluoromethane, dichlorodifluoromethane, tetrachloroethane, dichlorotetrafluoroethane, methylene chloride, ethyl chloride, nitrogen, oxygen, air, helium, argon, carbon dioxide, water, or a combination comprising at least one of the foregoing.

15. An expanded olefin resin particle comprising the expanded olefin resin of claim 1.

16. A process to produce an expanded olefin resin, comprising:
contacting a copolymer base resin with a blowing agent under a pressure greater than or equal to atmospheric pressure,
heating the copolymer base resin and the blowing agent to a temperature greater than or equal to the softening point of the olefin copolymer base resin, to produce an expanded olefin resin,
wherein copolymer base resin comprises about 99.95 to 99.999 weight percent of an olefin, and about 0.001 to 0.05 weight percent of an α-ω diene, and
wherein the copolymer base resin has a weight average molecular weight of about 30,000 to 500,000 Daltons, a crystallization temperature in a range from 115° C. to 135° C., and a melt flow rate in a range from 0.1 dg/min to 100 dg/min as determined using ASTM D-1238 at 230° C. and 2.16 kg load.

17. A foamed article comprising a foamed expanded olefin resin, wherein prior to foaming, the expanded olefin resin comprises a copolymer base resin and a blowing agent, wherein the copolymer base resin comprises about 99.95 to 99.999 weight percent of an olefin and about 0.001 to 0.05 wt % of an α-ω diene, wherein the copolymer base resin has a weight average molecular weight of about 30,000 to 500,000 Daltons, a crystallization temperature in a range from 115° C. to 135° C., and a melt flow rate in a range from 0.1 dg/min to 100 dg/min, as determined using ASTM D-1238 at 230° C. and 2.16 kg load, and wherein the foamed article has a bulk density of about 0.001 g/ml to about 0.8 g/ml.

18. A process to produce the foamed article comprising a foamed expanded olefin resin of claim 17, the process comprising:
heating the expanded olefin resin,
reducing the pressure being applied to the expanded olefin resin, or both, to produce an expanded foamed article.
